(19) United States
(12) Patent Application Publication
(10) Pub. No.: US 2026/0329664 A1
(43) Pub. Date: Oct. 22, 2026

(54) HYBRID RESOURCE QUOTA AUTO SCALING METHOD AND SYSTEM FOR KUBERNETES-BASED MULTI-CLUSTER CLOUD

(71) Applicant: FOUNDATION OF SOONGSIL UNIVERSITY-INDUSTRY COOPERATION, Seoul (KR)

(72) Inventor: Young Han KIM, Seoul (KR)

(73) Assignee: FOUNDATION OF SOONGSIL UNIVERSITY-INDUSTRY COOPERATION, Seoul (KR)

(21) Appl. No.: 19/424,504

(22) Filed: Dec. 18, 2025

(30) Foreign Application Priority Data
Apr. 16, 2025 (KR) 10-2025-0049390

(51) Int. Cl. G06F 9/50; G06F 9/455; G06N 20/00

(52) U.S. Cl. CPC G06F 9/5077; G06F 9/45558; G06N 20/00; G06F 2009/45591; G06F 2209/5019; G06F 2209/503

(57) ABSTRACT

A hybrid resource quota auto scaling method and system for Kubernetes-based multi-cluster cloud. The hybrid resource quota auto scaling system implemented within a management cluster connected to a plurality of member clusters includes: a monitoring unit configured to collect real-time metrics including resource usage data and namespace level metrics from the plurality of member clusters; a workload prediction unit configured to predict future workload demand by using past and real-time metrics and a pre-trained machine learning model; a proactive scaler configured to anticipate resource demand based on the predicted future workload demand and preemptively adjust a resource quota; and a reactive scaler configured to dynamically adjust a resource quota according to the real-time metrics.

### CROSS-REFERENCE TO RELATED APPLICATIONS

This application claims the benefit of Korean Patent Application 10-2025-0049390 filed on Apr. 16, 2025, in the Korean Intellectual Property Office. All disclosures of the document named above are incorporated herein by reference.

### TECHNICAL FIELD

The present invention relates to a hybrid resource quota auto scaling method and system for a Kubernetes-based multi-cluster cloud

### BACKGROUND ART

In a hybrid cloud environment that combines a public cloud and a private cloud, resource management becomes a critical issue. Public clouds are generally more expensive than private clouds and are shared in a multi-tenant environment.

To optimize costs, the use of public cloud resources is typically subject to strict quota limitations, and workload deployment is prioritized in the private cloud.

In a Kubernetes-based multi-cluster environment, maximum resource quotas are set for each service or tenant. This allows systematic management of resource quotas and ensures fair allocation. It also prevents specific services from excessively consuming resources and enables optimal utilization of limited edge resources, thereby supporting more stable and efficient system operations.

To handle dynamic workload demands, Kubernetes provides auto-scaling mechanisms that can scale workloads within the quotas.

Representative auto scaling methods comprise Horizontal Pod Autoscaling (HPA) and Vertical Pod Autoscaling (VPA).

HPA adjusts the number of Pods based on metrics such as CPU or memory usage.

VPA automatically adjusts the CPU and memory resources allocated to individual Pods to match workload demands.

However, these auto scaling mechanisms operate only within fixed resource quotas, and Kubernetes currently does not support dynamic adjustment of resource quotas.

When the auto scaling mechanism operates only within a fixed resource quota, it may face limitations in scaling the workload when unexpected traffic surges occur.

### DISCLOSURE

### Technical Problem

To address the problems of the prior art described above, the present invention proposes a hybrid resource quota scaling method and system for a Kubernetes-based multi-cluster cloud, which maximizes resource utilization and maintains system stability in a hybrid cloud multi-cluster environment.

### Technical Solution

According to one embodiment of the present invention, a hybrid resource quota auto scaling system implemented within a management cluster connected to a plurality of member clusters comprises a monitoring unit configured to collect real-time metrics including resource usage data and namespace level metrics from the plurality of member clusters; a workload prediction unit configured to predict future workload demand by using past and the real-time metrics and a pre-trained machine learning model; a proactive scaler configured to anticipate resource demand based on the predicted future workload demand and preemptively adjust a resource quota; and a reactive scaler configured to dynamically adjust a resource quota according to the real-time metrics.

The machine learning model may use at least one of an LSTM, a GRU (Gated Recurrent Unit), a Bi-LSTM, a Transformer, a Temporal Fusion Transformer (TFT), and a TCN (Temporal Convolutional Network) model to predict the future workload demand.

The proactive scaler may evaluate cluster resource availability to determine whether current resources can satisfy the future workload demand when the future workload demand is expected to increase, adjust resource quota to match the future workload demand when the current resources can satisfy the future workload demand, and update the adjusted resource quota using a FederatedResourceQuota (FRQ) CustomResourceDefinition (CRD).

The proactive scaler may calculate required additional resources when the current resources cannot satisfy the future workload demand, determine the number of additional worker nodes according to the calculated additional resources, and activate a waiting node that was pre-provisioned in standby mode.

The proactive scaler may perform scale-down according to quota levels distinguished by predefined thresholds when the future workload demand is predicted to decrease.

The proactive scaler may identify the least-utilized worker node and evaluate whether the workload can be migrated to other active nodes when the future workload demand is predicted to decrease.

The reactive scaler may dynamically adjust the resource quota of the member clusters by using the FederatedResourceQuota CR when resource shortage is detected based on the real-time metrics.

The reactive scaler may immediately proceed with workload deployment when an incoming workload request is less than or equal to a current quota, and when the incoming request exceeds the current quota, calculate a shortfall between a required quota and the current quota, update to increase the quota by the shortfall if available cluster resources can satisfy the shortfall, and apply the updated quota to the FederatedResourceQuota (FRQ) to proceed with the deployment without interruption.

According to another embodiment of the present invention, a resource quota auto scaling method performed in a management cluster connected to a plurality of member clusters comprises collecting real-time metrics including resource usage data and namespace level metrics from the plurality of member clusters; predicting future workload demand using past and real-time metrics and a pre-trained machine learning model; preemptively adjusting a resource quota by anticipating resource demand based on the predicted future workload demand through a proactive scaler; and dynamically adjusting a resource quota according to the real-time metrics through a reactive scaler.

According to yet another embodiment of the present invention, a computer program that performs the above method stored in a computer-readable recording medium is provided.

### Advantageous Effects

According to the present invention, by combining proactive and reactive scaling approaches, the system can respond to workload changes in real time within a multi-cluster environment, thereby reducing unnecessary resource waste and optimizing costs.

In addition, according to the present invention, even in the case of a sudden increase in workload, immediate scaling can be performed without latency, minimizing service downtime.

Furthermore, according to the present invention, private cloud resources are utilized first, and public cloud resources are scaled when necessary, thereby achieving both cost savings and performance optimization.

### DESCRIPTION OF DRAWINGS

These and/or other aspects will become apparent and more readily appreciated from the following description of the embodiments, taken in conjunction with the accompanying drawings, in which:

FIG. 1 is an overview diagram of the hybrid resource quota auto scaling system for a Kubernetes-based multi-cluster infrastructure according to an embodiment of the present invention.

FIG. 2 is a flowchart illustrating the operation of the proactive and reactive auto scaling mechanisms according to an embodiment of the present invention.

FIG. 3 is a block diagram showing the internal configuration of the hybrid resource quota auto scaling system according to an embodiment of the present invention.

FIG. 4 is a diagram illustrating the operation of the reactive scaler according to an embodiment of the present invention.

FIG. 5 is a diagram depicting the reactive scaling algorithm according to an embodiment of the present invention.

### DETAILED DESCRIPTION OF EMBODIMENTS

The present invention may be modified in various ways and may have several embodiments. Certain embodiments are illustrated in the drawings and will be described in detail in the specification. However, this is not intended to limit the present invention to specific embodiments, and it should be understood to include all modifications, equivalents, and alternatives that fall within the spirit and scope of the invention.

The terminology used in this specification is for the purpose of describing particular embodiments only and is not intended to limit the invention. The singular forms used herein are intended to include the plural forms as well, unless the context clearly indicates otherwise. In this specification, terms such as “comprise” or “have” are intended to specify the presence of stated features, numbers, steps, operations, components, parts, or combinations thereof, but do not preclude the possibility of the presence or addition of one or more other features, numbers, steps, operations, components, parts, or combinations thereof.

In addition, the components of the embodiments described with reference to the accompanying drawings are not limited to the specific embodiments, and they may be implemented to be included in other embodiments within the scope of the technical spirit of the present invention. Furthermore, it is to be understood that, even if not separately described, multiple embodiments may naturally be integrated into a single embodiment.

Also, in the description with reference to the accompanying drawings, the same or corresponding reference numerals are used to denote the same or related components regardless of the figure numbers, and redundant descriptions thereof will be omitted. In the description of the present invention, detailed explanations of known technologies related to the invention will be omitted when it is deemed that such details would unnecessarily obscure the gist of the invention.

According to the present embodiment, a resource quota auto scaling framework is proposed that can dynamically adjust resource quotas to prevent indiscriminate resource consumption in a specific namespace within a hybrid cloud environment that combines private and public clouds using Kubernetes-based containerized infrastructure.

This framework integrates two core mechanisms, that is, proactive scaling and reactive scaling, to effectively manage resource quotas and meet service-level objectives (SLO).

Proactive scaling utilizes machine learning models to predict future resource demand and adjusts resource quotas in advance of increasing demand.

Through this, resources can be made immediately available to accommodate large workloads and minimize the risk of resource shortages during expected high-traffic periods.

Reactive scaling complements this by dynamically adjusting quotas in real time to address sudden traffic spikes or deviations from predictions, ensuring system stability and performance.

The framework according to the present embodiment integrates components such as real-time data collection and monitoring, resource demand prediction, quota adjustment, and node scaling with Kubernetes and the Karmada API.

The system according to the present embodiment uses data from Prometheus and kube-state-metrics to make accurate and informed decisions. In addition, when cluster-wide resources become insufficient, the system activates pre-provisioned worker nodes to promptly meet resource demand.

According to the present embodiment, the system ensures flexible management of resource quotas, reduces resource waste, improves resource efficiency, and maintains system stability under both predictable and unpredictable workload conditions.

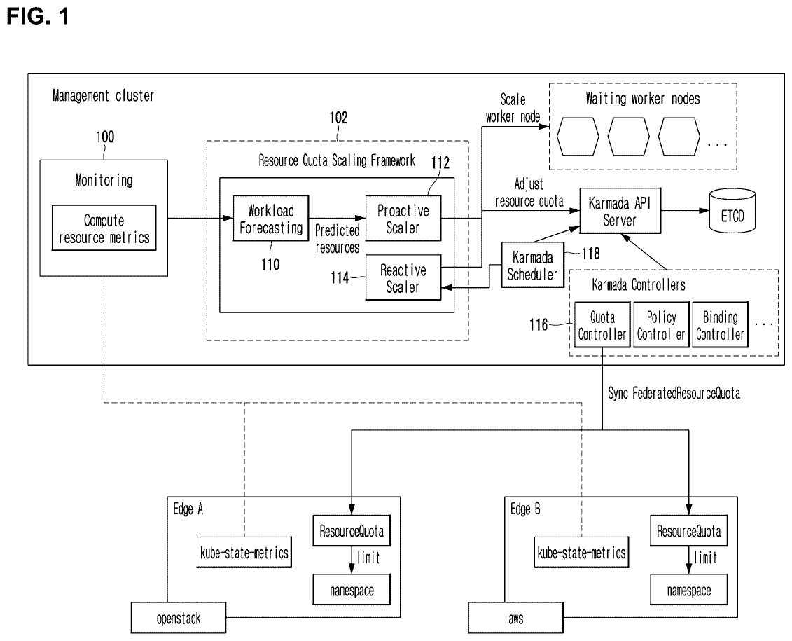

FIG. 1 is an overview diagram of the hybrid resource quota auto scaling system for a Kubernetes-based multi-cluster infrastructure according to the present embodiment.

Referring to FIG. 1, according to the present embodiment, the resource quota auto scaling system may comprise a monitoring unit 100 and a resource quota auto scaling unit 102, which are implemented within member clusters that deploy workloads to each cluster across a multi-cluster environment.

The monitoring unit 100 collects real-time metrics from a plurality of member (edge) clusters using Prometheus for resource usage data (CPU and memory) and kube-state-metrics for namespace-level metrics. These metrics serve as the foundation for prediction and scaling decisions.

The resource quota auto scaling unit 102 according to the present embodiment may comprise a workload prediction unit 110, a proactive scaler 112, a reactive scaler 114, and a quota controller 116.

The workload prediction unit 110 predicts future workload demand based on historical and real-time metrics using a machine learning model. These predictions allow the system to anticipate changes in resource requirements and plan scaling operations in advance.

The proactive scaler 112 anticipates resource demand based on predicted workload demand and adjusts resource quotas in advance. By scaling resource quotas preemptively, the system ensures that resources are available to meet predicted spikes in workload, reducing the risk of resource shortages or performance degradation during peak demand.

The reactive scaler 114 responds to scenarios in which resource demand cannot be accurately predicted or deviates significantly from predictions. It continuously monitors real-time metrics and dynamically adjusts quotas to ensure that workloads have sufficient resources. The reactive scaler 114 serves as a safeguard mechanism that addresses unexpected workload fluctuations or prediction inaccuracies and maintains system stability.

The quota controller 116 is integrated with the Karmada API server to apply decisions across the member clusters. The quota controller 116 dynamically updates FederatedResourceQuota (FRQ) to appropriately allocate resources among namespaces, ensuring that resource-intensive workloads are properly supported.

The scheduler 118 activates pre-provisioned worker nodes from a standby node pool when cluster-wide resources become insufficient. This enables additional physical resources to be made available quickly, minimizing delays in meeting scaling requirements.

Workload prediction according to the present embodiment enables proactive adjustment of resource quotas in a multi-cluster Kubernetes environment. Accurate prediction of resource demand is essential for aligning resource allocation with workload requirements and minimizing inefficiencies such as underutilization or excessive provisioning.

Conventional statistical methods, such as ARIMA have limitations in handling nonlinear and non-stationary characteristics of workload behavior. In contrast, Long Short Term Memory (LSTM) networks exhibit significant superiority in capturing such complex patterns, making them more suitable for workload prediction scenarios where rapid fluctuations are common.

To take advantage of these benefits, the present embodiment trains an LSTM model using the Alibaba Cloud cluster trace dataset.

This dataset contains detailed resource usage data from real-world environments, making it an ideal candidate for prediction experiments. The LSTM model is designed to predict resource demand for individual namespaces, enabling accurate adjustments of resource allocation at a granular level. Using a sliding window technique, the LSTM model takes past data as input to predict future intervals of CPU and memory usage. Key hyperparameters, including window size and learning rate, are optimized to improve model performance. Fine-tuning these hyperparameters allows the model to balance computational efficiency and prediction accuracy.

A comparison between the LSTM model and conventional approaches demonstrates the superior accuracy and reliability of LSTM in workload prediction tasks, effectively handling the complexity and variability of workload patterns, which often exhibit rapid changes and interdependencies. Furthermore, the LSTM model's ability to model temporal dependencies in workload pattern enables it to more effectively predict future demand trends than traditional methods.

Integrating the LSTM-based workload prediction technique into the system of the present embodiment not only ensures accurate resource allocation but also reduces risks associated with under-provisioning or over-provisioning. This level of accuracy supports seamless proactive resource quota adjustments, enabling the system to maintain stable performance and satisfy service-level objectives (SLO). By optimizing resource utilization and dynamically adapting to workload fluctuations, the LSTM model plays a key role in improving overall efficiency, resilience, and stability in a multi-cluster Kubernetes environment.

Although the above describes that future workload demand is predicted by using an LSTM model, it is not limited thereto, and various models such as GRU (Gated Recurrent Unit), Bi-LSTM, Transformer, Temporal Fusion Transformer (TFT), and TCN (Temporal Convolutional Network) may also be used.

Proactive resource quota scaling according to the present embodiment is a mechanism that dynamically adjusts resource quotas and manages worker nodes in a multi-cluster Kubernetes environment by using predicted workloads provided from the workload prediction model. By utilizing such predictions, the system can proactively scale resources to ensure optimal resource allocation aligned with expected workload demand and maintain system performance.

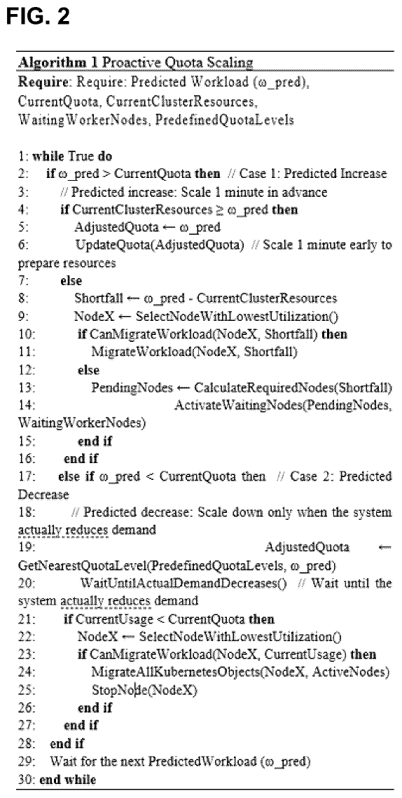

FIG. 2 is a flowchart illustrating the operation of the proactive and reactive auto scaling mechanisms according to the present embodiment.

FIG. 2 shows an algorithm that addresses both increases and decreases in resource demand to achieve efficient scaling.

When an increase in workload is predicted (ω_pred>CurrentQuota), the algorithm according to the present embodiment evaluates cluster resource availability to determine whether the current resources (CurrentClusterResources) can satisfy the predicted demand.

If the current resources are sufficient, the quota is directly adjusted to match the predicted workload, calculated as AdjustedQuota=ω_pred, and updated using the FederatedResourceQuota (FRQ) CustomResourceDefinition (CRD). This ensures that resources are immediately allocated without interrupting deployment.

If available resources are insufficient, the algorithm calculates the required additional resources, defined as Shortfall=ω_pred−CurrentClusterResources. It then determines the number of additional worker nodes required and activates waiting nodes that were pre-provisioned in a standby mode. Once the waiting nodes are activated, the quota is adjusted to accommodate the workload so deployment can proceed without delay. This proactive approach prevents deployment failures and ensures that resource-intensive workloads are properly supported.

Conversely, when a decrease in workload is predicted (ω_pred<CurrentQuota), the algorithm of the present embodiment initiates scale-down to optimize resource usage. The quota level is reduced according to a predefined threshold, ensuring that the system retains sufficient resources for the workload while avoiding excessive provisioning.

For example, in a system with predefined quota levels [20, 40, 60, 80, 100], if resource usage is 77, the quota is adjusted to 80.

If resource usage is 42, the quota is adjusted to 60, and if usage is 19, the quota is reduced to 20. The algorithm also identifies the least-utilized worker node and evaluates whether the workload can be migrated to other active nodes.

If redistribution is possible, the workload is migrated and the underutilized node is deactivated, reducing resource waste and operational costs. This scale-down strategy not only ensures efficient resource utilization but also minimizes idle resources, thereby improving the sustainability of the system. By combining predictive scaling with real-time adjustments, the proactive resource quota scaling mechanism ensures seamless operation and maintains service-level objectives (SLO) while keeping the system prepared for workload variability.

The reactive scaler 114 addresses unexpected or inaccurately predicted resource shortages in a dynamic multi-cluster Kubernetes environment.

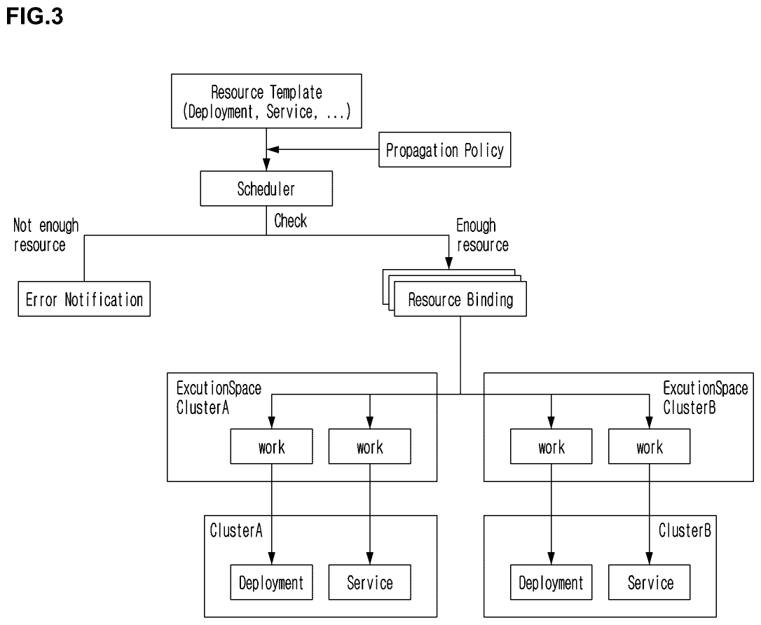

FIG. 3 is a block diagram showing the internal configuration of the hybrid resource quota auto scaling system according to the present embodiment.

Referring to FIG. 3, the default deployment workflow of Karmada checks the resources of member clusters after determining propagation policies and scheduling. If the required resources are not available, Karmada returns an error notification (e.g., “no policy match”) and terminates the deployment process.

This default behavior leads to significant delays in workload execution and unnecessary interruptions, limiting the flexibility and responsiveness of the orchestration system. To overcome these limitations, the system of the present embodiment employs the reactive scaler 114.

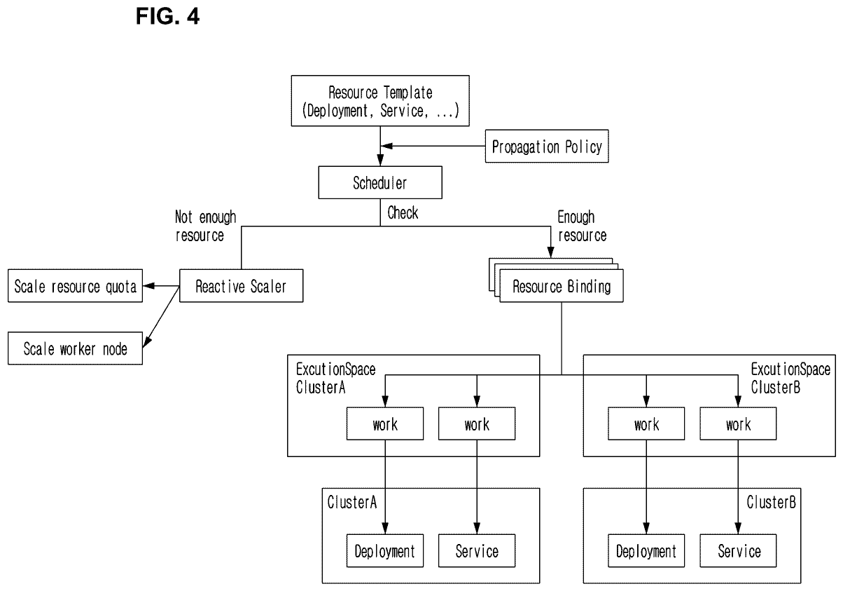

FIG. 4 is a diagram illustrating the operation of the reactive scaler according to the present embodiment.

Unlike the default workflow, when a resource shortage is detected, the reactive scaler 114 dynamically adjusts the resource quota of member clusters using the FederatedResourceQuota CR.

The reactive scaler 114 evaluates real-time workload requirement and current cluster resource availability, ensuring that additional resources are allocated immediately so deployment can proceed smoothly without manual intervention or interruption. If adjusting the resource quota is insufficient to satisfy the workload demand, the reactive scaler 114 can scale out additional worker nodes. These nodes are dynamically enabled to supplement the cluster's capacity, allowing even unexpected surges in demand to be handled efficiently.

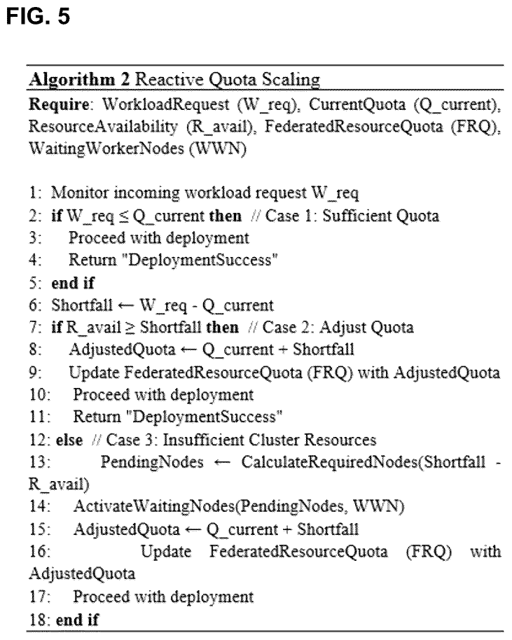

FIG. 5 is a diagram illustrating the reactive scaling algorithm according to the present embodiment.

Referring to FIG. 5, reactive scaling dynamically adjusts resource quotas in a multi-cluster Kubernetes environment according to incoming workload demand. The reactive scaling algorithm operates across three main cases to ensure seamless deployment and efficient resource utilization.

First, if the incoming workload request (W_req) is less than or equal to the current quota (Q_current), the system immediately proceeds with deployment, minimizing latency when existing resources are sufficient.

Second, when W_req exceeds Q_current, the algorithm calculates the shortfall between the required quota and the current quota. If available cluster resources (R_avail) can satisfy the shortfall, Q_current is increased by the shortfall to dynamically adjust the quota. The updated quota is then applied to the FederatedResourceQuota (FRQ) so that deployment can proceed without interruption.

Finally, in scenarios where cluster resources are insufficient, the algorithm of the present embodiment calculates the required number of additional worker nodes using the shortfall and resource availability. Pre-provisioned waiting worker nodes (WWN) are then activated to fill the resource gap. The quota is adjusted accordingly and updated in the FRQ, and deployment proceeds. This mechanism ensures that workloads are deployed even under resource constraints, maintaining service-level objectives (SLO). By integrating real-time monitoring, dynamic quota adjustment, and node activation, the reactive scaler 114 enhances Karmada's orchestration capabilities, optimizing resource allocation and minimizing deployment delays while addressing unpredictable workload scenarios.

The foregoing hybrid resource quota auto scaling method for a Kubernetes-based multi-cluster cloud may also be implemented in the form of a computer-readable recording medium containing program instructions executable by a computer, such as an application or program module. A computer-readable medium may be any available medium accessible by a computer processor and includes both volatile and non-volatile media as well as removable and non-removable media. Additionally, a computer-readable medium may include computer storage media. Computer storage media include both volatile and non-volatile, removable and non-removable media, implemented in any method or technology for storing information such as computer-readable instructions, data structures, program modules, or other data.

The embodiments described herein are disclosed for illustrative purposes, and various modifications, changes, and additions can be made by those skilled in the art without departing from the spirit and scope of the invention. Such modifications, changes, and additions should be considered as falling within the scope of the following claims.

1. A hybrid resource quota auto scaling system implemented within a management cluster connected to a plurality of member clusters comprising:
a monitoring unit configured to collect real-time metrics including resource usage data and namespace level metrics from the plurality of member clusters;
a workload prediction unit configured to predict future workload demand by using past and the real-time metrics and a pre-trained machine learning model;
a proactive scaler configured to anticipate resource demand based on the predicted future workload demand and preemptively adjust a resource quota; and
a reactive scaler configured to dynamically adjust a resource quota according to the real-time metrics.

2. The hybrid resource quota auto scaling system of claim 1, wherein the machine learning model uses at least one of an LSTM, a GRU (Gated Recurrent Unit), a Bi-LSTM, a Transformer, a Temporal Fusion Transformer (TFT), and a TCN (Temporal Convolutional Network) model to predict the future workload demand.

3. The hybrid resource quota auto scaling system of claim 1, wherein the proactive scaler,
evaluates cluster resource availability to determine whether current resources can satisfy the future workload demand when the future workload demand is expected to increase,
adjusts resource quota to match the future workload demand when the current resources can satisfy the future workload demand, and
updates the adjusted resource quota using a FederatedResourceQuota (FRQ) CustomResourceDefinition (CRD).

4. The hybrid resource quota auto scaling system of claim 3, wherein the proactive scaler,
calculates required additional resources when the current resources cannot satisfy the future workload demand,
determines the number of additional worker nodes according to the calculated additional resources, and
activates a waiting node that was pre-provisioned in a standby mode.

5. The hybrid resource quota auto scaling system of claim 1, wherein the proactive scaler performs scale down according to quota levels distinguished by predefined thresholds when the future workload demand is predicted to decrease.

6. The hybrid resource quota auto scaling system of claim 5, wherein the proactive scaler identifies the least-utilized worker node and evaluates whether the workload can be migrated to other active nodes when the future workload demand is predicted to decrease.

7. The hybrid resource quota auto scaling system of claim 1, wherein the reactive scaler dynamically adjusts the resource quota of a member cluster by using the FederatedResourceQuota CR when resource shortage is detected based on the real-time metrics.

8. The hybrid resource quota auto scaling system of claim 7, wherein the reactive scaler,
immediately proceeds with workload deployment when an incoming workload request is less than or equal to a current quota, and
when the incoming request exceeds the current quota, calculates a shortfall between a required quota and the current quota,
updates to increase the quota by the shortfall if available cluster resources can satisfy the shortfall, and
applies the updated quota to the FederatedResourceQuota (FRQ) to proceed with the deployment without interruption.

9. A resource quota auto scaling method performed in a management cluster connected to a plurality of member clusters comprising:
collecting real-time metrics including resource usage data and namespace level metrics from the plurality of member clusters;
predicting future workload demand using past and the real-time metrics and a pre-trained machine learning model;
preemptively adjusting a resource quota by anticipating resource demand based on the predicted future workload demand through a proactive scaler; and
dynamically adjusting a resource quota according to the real-time metrics through a reactive scaler.

10. The hybrid resource quota auto scaling method of claim 9, wherein the machine learning model uses at least one of an LSTM, a GRU (Gated Recurrent Unit), a Bi-LSTM, a Transformer, a Temporal Fusion Transformer (TFT), and a TCN (Temporal Convolutional Network) model to predict the future workload demand.

11. The hybrid resource quota auto scaling method of claim 9, wherein the preemptive adjusting comprises,
evaluating cluster resource availability to determine whether current resources can satisfy the future workload demand when the future workload demand is expected to increase; and
adjusting the resource quota to match the future workload demand, and updating the adjusted resource quota using a FederatedResourceQuota (FRQ) CustomResourceDefinition (CRD) when the current resources can satisfy the future workload demand.

12. The hybrid resource quota auto scaling method of claim 11, wherein the preemptively adjusting comprises,
calculating required additional resources when the current resources cannot satisfy the future workload demand;
determining the number of additional worker nodes according to the calculated additional resources and activating a waiting node that was pre-provisioned in a standby mode; and
performing scale down according to quota levels distinguished by predefined thresholds when the future workload demand is predicted to decrease.

13. The hybrid resource quota auto scaling method of claim 12, wherein the preemptively adjusting comprises identifying the least-utilized worker node and evaluating whether the workload can be migrated to other active nodes when the future workload demand is predicted to decrease.

14. The hybrid resource quota auto scaling method of claim 9, wherein the dynamically adjusting comprises,
immediately proceeding with workload deployment when an incoming workload request is less than or equal to a current quota;
calculating a shortfall between a required quota and the current quota when the incoming request exceeds the current quota;
updating to increase the quota by the shortfall if available cluster resources can satisfy the shortfall; and
applying the updated quota to the FederatedResourceQuota (FRQ) to proceed with workload deployment without interruption.

15. A computer program that performs the method of claim 9 stored in a computer-readable recording medium.
